(19) United States
(12) Patent Application Publication
(10) Pub. No.: US 2015/0052019 A1
(43) Pub. Date: Feb. 19, 2015

(54) System and Method for Multiple Weighted Factor Routing Schemes in Heterogeneous Fulfillment Networks Serving Multiple Clients with Distinct Routing Policies

(71) Applicant: Nordstrom Inc., Seattle, WA (US)

(72) Inventors: Kelli Field-Darraugh, Snoqualmie, WA (US); Garth Vance, Bellevue, WA (US); Aaron Dane, Seattle, WA (US); Stuart Bayless, Seattle, WA (US); William Quan, Redmond, WA (US)

(21) Appl. No.: 14/463,398

(22) Filed: Aug. 19, 2014

Related U.S. Application Data
(60) Provisional application No. 61/867,526, filed on Aug. 19, 2013.

(51) Int. Cl. G06Q 30/06; G06Q 10/08

(52) U.S. Cl. CPC G06Q 30/0635; G06Q 10/087
USPC 705/26.62

(57) ABSTRACT

An enterprise fulfillment system for order fulfillment from a heterogeneous fulfillment network is shown having a server configured to connect to a communication network to communicate with an ordering system and obtain inventory data from the nodes of the fulfillment network. The server receives a customer query regarding a product from the ordering system, identifies nodes in the fulfillment network stock of the product, and scores fulfillment options from the fulfillment network based on a routing schema. The server replies to the ordering system with rank ordered fulfillment options. The system may provide independent routing schema for different clients that provides different fulfillment options from the fulfillment network for each client. An interface may be provided permitting the routing schema to be revised by a client or based on dynamic data. The fulfillment network may include nodes from client, enterprise and vendor networks having different inventory, capabilities and cost.

### CROSS REFERENCE TO RELATED APPLICATIONS

This application claims the benefit of priority to U.S. Patent Application No. 61/867,526 filed Aug. 19, 2013 entitled “System and Method for Multiple Weighted Factor Routing Schemes in Heterogeneous Fulfillment Networks Serving Multiple Clients with Distinct Routing Policies,” which is incorporated by reference herein in its entirety for all purposes.

### BACKGROUND OF THE INVENTION

Retail sellers of goods generally fulfill customer orders through a variety of means. For example, a merchandiser may have a variety of nodes, such as multiple physical stores, an on-line presence, warehouses, which may include fulfillment centers (FCs) and store reserve stock (RS), outlets, and other facilities, that constitute the merchandiser's fulfillment network. Each of the nodes in the fulfillment network has different stock for any given item as well as different capabilities for customer service, e.g. gift wrap, expedited delivery, etc.

An on-line customer portal will typically be best suited to offering stock at nodes where stock can be tracked and inventoried in a database, such as reserve stock at a warehouse. It is much more problematic for an on-line interface to provide access to stock at other nodes, such as retail stores, outlets or salvage facilities. A salesperson can sometimes be more flexible in accessing various nodes of the fulfillment network, e.g. the saleperson's store, other stores, warehouse, to locate an item for sale to a customer. However, this has typically been time-consuming and laborious, e.g. checking the store's backroom, checking inventory, calling other stores, and/or calling the warehouse. Further, access is normally limited to the merchandiser's own fulfillment network.

### SUMMARY OF THE INVENTION

An enterprise fulfillment system for order fulfillment from a heterogeneous fulfillment network is shown having a server configured to connect to a communication network to communicate with an ordering system and obtain inventory data from the nodes of the fulfillment network. The server receives a customer query regarding a product from the ordering system, identifies nodes in the fulfillment network stock of the product, and scores fulfillment options from the fulfillment network based on a routing schema. The server replies to the ordering system with rank ordered fulfillment options. The system may provide independent routing schema for different clients that provides different fulfillment options from the fulfillment network for each client. An interface may be provided permitting the routing schema to be revised by a client or based on dynamic data. The fulfillment network may include nodes from client, enterprise and vendor networks having different inventory, capabilities and cost. In a further refinement, the server is configured to evaluate nodes for fulfillment on the basis of multiple factors such as quality, capacity, value added services available, cost, shipping services available, cost of shipping, location proximate to an end customer for the product, age of inventory, quality of inventory, price, velocity of sales, margin, and customer history. An interface may be provided to permit rules or weight factors for routing schema to be revised.

A method is shown for automatically determining fulfillment options in a heterogenous fulfillment network that involves obtaining current inventory data from at least one node of the heterogeneous fulfillment network, receiving a query regarding a first product, and, responsive to the query, identifying nodes in the fulfillment network having stock corresponding to the first product. The method also involves scoring fulfillment options from each of the nodes having stock corresponding to the first product based on a first routing schema and returning at least one fulfillment option based on a rank order of the scored fulfillment options.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

Various embodiments in accordance with the present disclosure will be described with reference to the drawings, in which:

FIG. 1 is a schematic diagram depicting aspects of an example computing environment in which an embodiment of the invention may be implemented;

FIG. 2 is a functional block diagram illustrating multiple heterogeneous fulfillment networks in communication with a routing engine in accordance with at least one embodiment of the invention;

FIG. 3 is a functional block diagram illustrating one example of data for a routing engine serving multiple clients through multiple heterogeneous fulfillment networks in accordance with at least one embodiment of the invention;

FIG. 4 is a control flow diagram illustrating an example of a process for routing an order in a routing engine with multiple clients and issuing fulfillment requests to heterogeneous fulfillment networks in accordance with at least one embodiment of the invention;

FIG. 5 is a control flow diagram illustrating an example in accordance with at least one embodiment of the invention of a process for obtaining routing options available for a product in a routing engine serving both an enterprise and a client and based on real-time data from heterogeneous fulfillment networks for the client, the enterprise and a vendor;

FIG. 6 is an illustration of an example of an interface that may be supported by the enterprise ordering system of FIG. 1, wherein a customer has selected three products and the ordering system sent a query to the routing engine, which scored the available options for fulfilling a potential order;

FIG. 7 illustrates another example of an interface wherein a salesperson using a mobile client device has selected three products for a high value customer and the enterprise ordering system sent a query to the routing engine, which scored the available options for fulfilling a potential order for Customer B and returned three available options to the enterprise ordering system for display via the interface;

FIG. 8 illustrates still another example of an interface wherein a customer of a client entity is being serviced from the client's ordering system and options are offered based on the client's routing rules or weights as processed by the enterprise routing engine;

FIG. 9 is a control flow diagram illustrating an example of a process for scoring an order for routing in a routing engine using multiple factors in order to apply weighted routing rules in accordance with at least one embodiment of the invention;

FIG. 10 illustrates an interface that may be supported by the client or enterprise ordering systems of FIG. 1 wherein fulfillment options are presented based on a level of operational cost for fulfillment;

FIG. 11 is a control flow diagram that illustrates an example of a process for scoring fulfillment options based on a combination of items in a customer order and evaluating whether the resulting option meets a service requirement for the order;

FIG. 12 illustrates an example of a customer order interface wherein a product has been added by a customer to the order shown in FIG. 10 and the fulfillment options have been re-evaluated based on the products in the modified order;

FIG. 13 is a control flow diagram that illustrates an example of a process for re-evaluating fulfillment options when additional products are selected;

FIG. 14 illustrates an example of a customer order interface wherein costs of delivery are not shown to the customer and the routing engine can fulfill the order in accordance with the enterprise's routing rules and weights without offering a customer fulfillment alternatives;

FIG. 15 illustrates an example of a customer order interface wherein the enterprise fulfillment rules are configured to fulfill a customer order at a higher quality of service at no additional cost to the customer;

FIG. 16 is a table illustrating several examples of costs for consolidated and non-consolidated fulfillment;

FIG. 17 is a control flow diagram illustrating an example of a process for evaluating cost differentials between consolidated and non-consolidated fulfillment and evaluation of a service upgrade;

FIG. 18 is a functional block diagram illustrating an example of a network of interconnected devices suitable for use with at least one embodiment of the invention; and

FIG. 19 is a functional block diagram illustrating an example of a computing device suitable for use with at least one embodiment of the invention.

### DETAILED DESCRIPTION OF PREFERRED EMBODIMENTS

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

In one aspect of the present invention, a system and method is provided that automatically ascertains options for routing orders through a fulfillment network having heterogeneous nodes based on multiple factors, such as real-time availability of stock, capacity, sales velocity (e.g. rate that orders have executed at a node), margin, markdown avoidance, quality of stock, delivery time, special services, customer history, where weighting of the different factors may be specified to tailor the performance of the system.

In another aspect of the present invention, fulfillment options may be assessed across multiple fulfillment networks, such as an enterprise fulfillment network in combination with third party networks, such as client and vendor networks.

In still another aspect of the present invention, an enterprise routing engine processes order fulfillment for one or more third party clients, who may have a routing schema, e.g. policies or weighting of factors, that is different and distinct from the routing schema of the enterprise. In a refinement of this aspect of the invention, an interface is provided to the third party client permitting real-time revision of the client's routing schema. In another refinement of this aspect of the invention, order fulfillment for a third party client may be made from a third party vendor's fulfillment network.

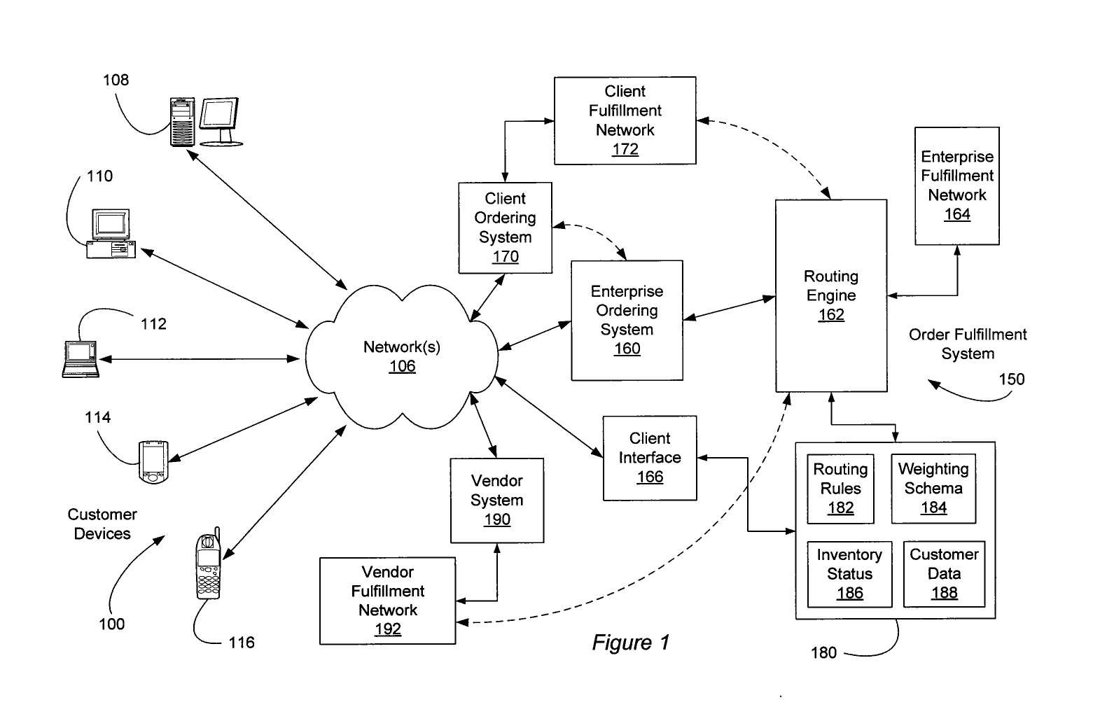

FIG. 1 is a schematic diagram depicting aspects of one example of a computing network architecture in which an embodiment of the invention may be implemented. As shown, a variety of clients 100 incorporating and/or incorporated into a variety of computing devices may communicate with an enterprise order fulfillment system or service through one or more networks 106. For example, a client may incorporate and/or be incorporated into a client application (e.g., software) implemented at least in part by one or more of the computing devices. Examples of suitable computing devices include personal computers, server computers 108, desktop computers 110, laptop computers 112, notebook computers, personal digital assistants (PDAs) 114, smart phones 116, cell phones, point of sale or cash register systems, and consumer electronic devices incorporating one or more computing device components such as one or more processors, central processing units (CPU), or controllers. Examples of suitable networks 106 include networks utilizing wired and wireless communication technologies and networks operating in accordance with any suitable networking and/or communication protocol (e.g., the Internet). One of ordinary skill in the art will recognize that other computing devices and communication networks may be used to implement the invention.

The enterprise order fulfillment system may include one or more user interfaces, an application, and data storage. The user interface may include graphical user interfaces and/or web-based interfaces. The user interfaces may include a default user interface for the service, as well as one or more user interfaces extended by one or more clients of the service (e.g., via access to one or more APIs). The user interface may include components enabling clients to query the enterprise order fulfillment system for fulfillment options and to process orders and an interface to allow the client to revise a routing schema for the client's orders. Note that each system shown may be implemented with a set of computers and/or computer components including computer servers and processors, and may perform various functions, methods, processes, or operations as determined by the execution of a software application or set of instructions. A data storage tier may include one or more production data stores and one or more testing, validation and/or backup data stores. Data stores may be implemented with any suitable data storage technology including structured query language (SQL) based relational database management systems (RDBMS).

In the example of FIG. 1, the enterprise order fulfillment system 150 includes an enterprise ordering system 160, which can receive queries and, in response, provide fulfillment options, and process the orders received. The enterprise ordering system 160 is in communication with a client ordering system 170 through network 106 such that it can receive queries from the client ordering system 170 and respond with fulfillment options. Similarly, the enterprise ordering system 160 can receive an order from the client ordering system 170, where the enterprise ordering system 160 executes on the order to complete a fulfillment transaction.

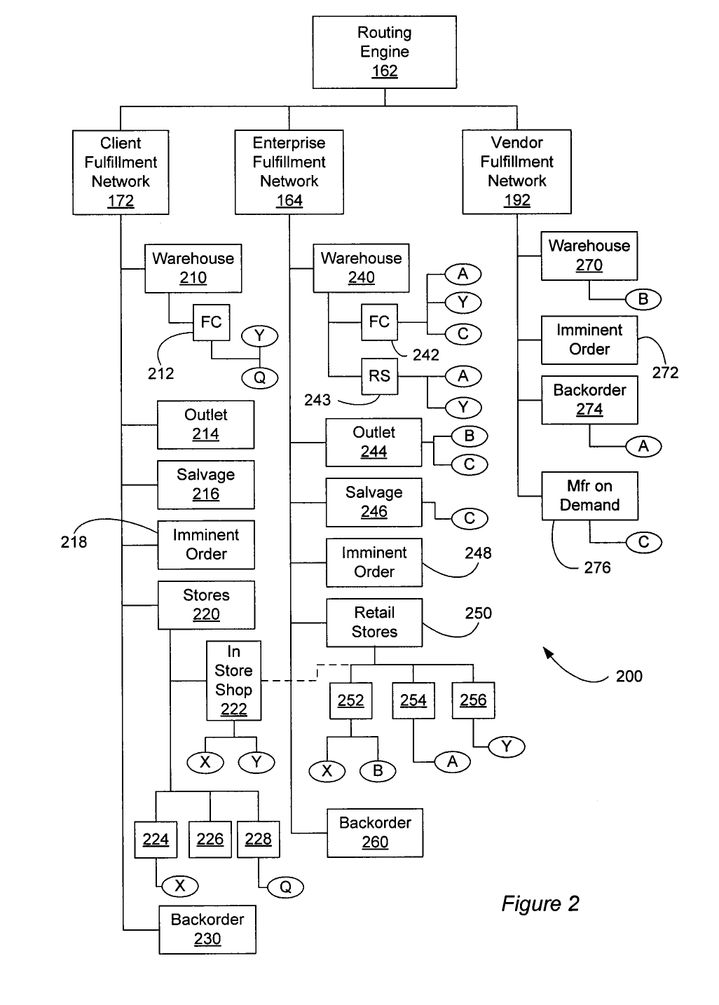

The enterprise ordering system 160 is coupled to a routing engine 162 connected to an enterprise fulfillment network 164, which represents the enterprise's facilities for fulfilling an order. Examples of fulfillment networks are shown in FIG. 2. The routing engine 162 receives status information from the enterprise fulfillment network 164, such as real-time inventory quantities, locations, capacity and available services at the various fulfillment nodes of the network. The routing engine 162 may also issue a fulfillment order to cause an item to be delivered to a customer from the fulfillment network 164.

The routing engine 162 is also coupled to a data storage 180 that contains, in this example, routing rules 182 used to assess and/or score fulfillment options, weighting schema 184 with weights for factors considered in the routing rules 182, inventory status 186 with information about items such as quantity and location, and customer data 188, which may include information about a customer's special status or past purchasing habits.

In the example shown, the routing engine 162 also has logical connections to the client 172 and vendor 192 fulfillment networks to obtain up-to-date status information regarding stock in those networks. In one embodiment of the present invention, the routing engine 162 is able to provide fulfillment options from and execute fulfillment orders in the client 172, vendor 192, or enterprise 164 fulfillment networks or a subset of those networks. The routing engine 162 may be in communication with all or part of the enterprise 164, client 172 and vendor 192 networks via network 106.

In the example shown, the enterprise ordering system 160 is in communication with the client ordering system 170, which is in communication with the client fulfillment network 172, and a vendor system 190, which is in communication with a vendor fulfillment network 192. Note that there may be multiple client ordering systems or vendor systems that may be in communication with the enterprise ordering system via network 106 and other architectures that are suitable for application of the present order fulfillment system 150 without departing from the spirit of the invention. For example, one or more components of the enterprise 164, client 172 and vendor 192 fulfillment networks may be directly coupled to the network 106.

The enterprise ordering system 160 may receive queries directly from customers, such as the users of customer devices 100, through a customer user interface, which may be implemented at least partially in applications residing on customer devices, customer service devices, or through a web interface. When the enterprise ordering system 160 receives a potential order, e.g. an item in an on-line shopping cart, it queries the routing engine 162 for available fulfillment options for the item. In one example, the routing engine 162 applies the routing rules with the associating weighting schema 184 to score each available fulfillment option for the item and one or more of the options with the highest scores are returned to the enterprise ordering system 160 for display to a customer. Depending on the configuration of the system 150, the fulfillment options may include available options from third party vendor fulfillment networks 192 in addition to the enterprise fulfillment network 164.

The enterprise ordering system 160 may also receive queries from the client ordering system. In this example, the client ordering system may provide a shopping interface to customers, but order fulfillment is provided through the enterprise order fulfillment system 150. The client ordering system 170 sends a query for an item to the enterprise ordering system 160, which scores the available fulfillment options, which may include options from the client fulfillment network 172. Also, the client may have different routing rules or weighting than those for the enterprise, in which case the client's order may be serviced differently from the enterprise's orders. The client may establish a rule or set a weighting factor such that fulfillment options from the client fulfillment network 172 are given higher scores for client orders than options involving the enterprise 164 or vender 192 networks.

Thus, the client originated order can result in different fulfillment options being offered to a customer than an order for the same item originating in the enterprise ordering system 160. A client interface 166 may be provided that permits a third party client to revise the rules or set the weighting schema for the client's orders. In this manner, the enterprise order fulfillment system 150 may provide the third party clients' order fulfillment services so that it may be unnecessary for the third party client to maintain their own fulfillment system. Note that the third party client may have no or a very limited client fulfillment network 172 so that the client's orders are serviced entirely by the enterprise system 150.

The architecture illustrated in FIG. 1 is substantially a centralized architecture with respect to the enterprise, client and vendor systems. However, it is also possible to implement the present invention in a distributed architecture where services, computation resources, and data are distributed across multiple devices, e.g. a server farm or multiple devices, each performing some of the functionality. Information may come from many sources both within and outside of the enterprise. Data may be stored in more than one place with data physically distributed and/or replicated in different devices or storage units, through data sharing and caching. All or some of the functionality may be implemented in a cloud based architecture, where one or more of a system's services, functionality or data are physically hosted in one or more remote data centers.

Furthermore, while systems are shown as centralized, e.g. client or enterprise systems, each system may have, for example, multiple ordering systems related to internal clients, e.g. separate divisions with different product lines. For example, a division or subsidiary within an enterprise may originate its own orders through its own order system with fulfillment determined by one or more routing rules and weights specific to the division, e.g. the division is treated as a client.

One aspect of the present invention is providing fulfillment options from a variety of nodes in a fulfillment network having different stock, services or capabilities. FIG. 2 is a functional block diagram illustrating examples of multiple heterogeneous fulfillment networks 172, 164 and 192 in communication with a routing engine 162 in accordance with an embodiment of a fulfillment system. FIG. 2 is one example of fulfillment networks and reflects the example fulfillment system shown in FIG. 1. A fulfillment network may include one or more warehouses having inventory of reserve stock (RS), which may need to be transferred to another facility for shipping to a customer, or a fulfillment center (FC), which may have the capability of packing and shipping an item directly to a customer. Fulfillment networks may include outlet facilities, salvage facilities for recovering returned merchandise, as well as one or more retail stores, where each node has its own inventory. In-store inventory may be picked from back room stock or even display racks and shipped to another store or to the customer with gift wrapping as an optional service. Other possible fulfillment nodes include an imminent order option, where stock on order can be reserved to fulfill a customer's order, and a backorder option, where the item can be backordered from a supplier. In addition, a network may also include at option to have an item manufactured to order. Some clients, such as premium or luxury brands, may also have specialty shops that are located on other premises, e.g. the retail stores of the enterprise.

While the example shows fulfillment networks for a client, an enterprise and a vendor, systems in accordance with various aspects of the present invention may vary from the example shown without departing from the teachings of the invention. For example, multiple client fulfillment networks may be integrated into the system or no client fulfillment network. Similarly, multiple vendor fulfillment networks may be coupled to the system or no vendor fulfillment network.

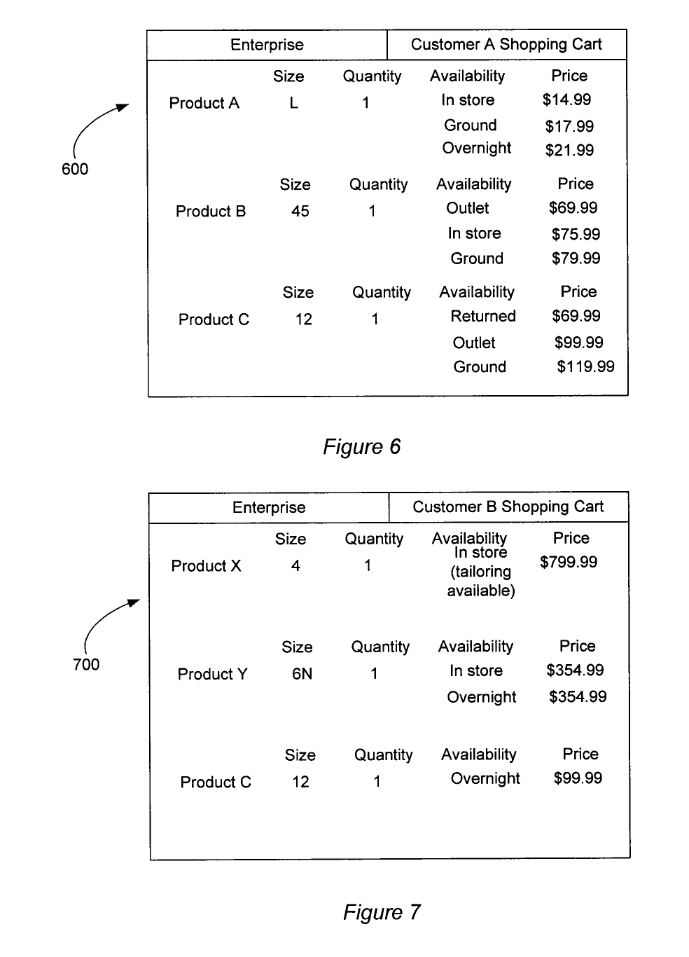

Furthermore, individual fulfillment networks need not include all of the various types of fulfillment nodes shown in FIG. 2. For example, each network may have more or less of a particular type of node, may not include all of the nodes shown, and may include different nodes from those shown. Generally, the example shown illustrates how networks may have different fulfillment nodes with different capabilities and different inventory. To illustrate differences in inventory and capability and how different routing rules or weights may impact the scoring for different fulfillment options, products are shown as being stocked at particular nodes. For example, a fulfillment center 242 in the enterprise network 164 is shown as having Products A, Y and C in stock, while reserve stock 243 for the enterprise has Products A and Y in stock. Similarly, a fulfillment center 212 within the client fulfillment network 172 is shown as having Products Y and Q in stock, while Products X and Y are available at an in-store specialty shop 222 that is physically located within the one of the retail stores of enterprise network 164. These inventory examples are discussed further below with respect to FIGS. 6, 7 and 8.

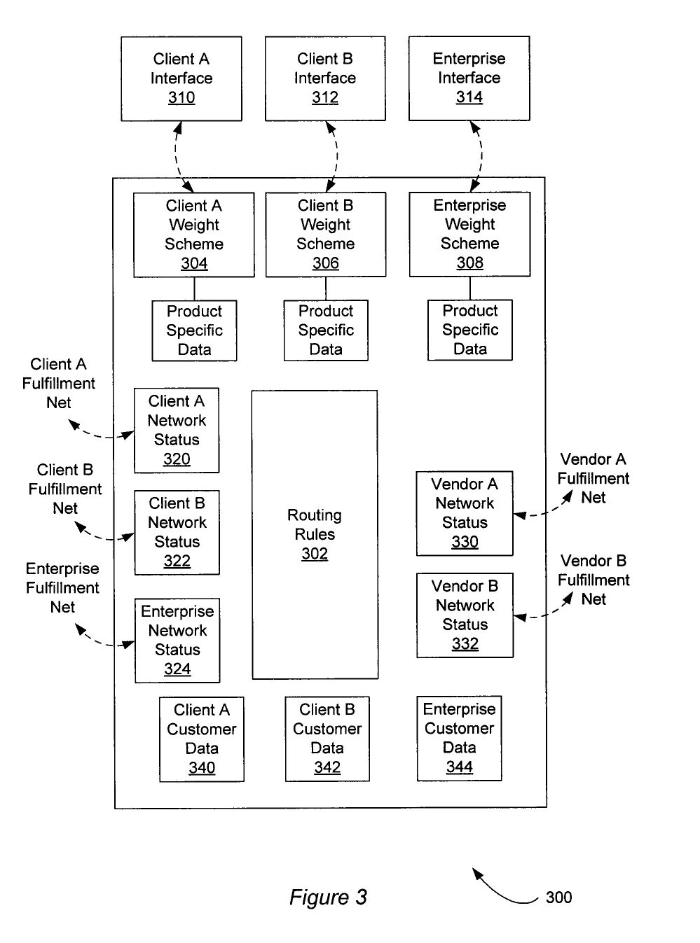

FIG. 3 is a functional block diagram illustrating one example of data for a routing engine serving multiple clients through multiple heterogeneous fulfillment networks in accordance with at least one embodiment of the invention. The figure shows one example of the data that may be stored and utilized with a set of routing rules to route orders or determine availability options.

In this example, a set of routing rules is stored along with three independent weighting schema for Client A 304, Client B 306, and the enterprise itself 308. Each of the weighting schema is shown with a corresponding interface 310, 312 and 314 that permits the weighting values in the schema to be revised. By revising the weighting schema, each of the clients and the enterprise can effect customized routing functionality with respect to the routing rules 302 of the order fulfillment system. Note that while one set of routing rules 302 is shown, it is possible to have other embodiments wherein each entity has independent routing rules. For example, a client may have a routing rule requiring that fulfillment only take place from the client's fulfillment network 172 even though inventory exists in other fulfillment networks. In this example, product specific data for each entity is also stored so that specific product and handling requirements can be taken into account in the routing function. Examples of criteria for routing rules and or weighting factors may include one or more of: margin, volume, service, customer loyalty, cost, deliverability, customer retention model, customer acquisition model, business model (e.g. premium, value), aging inventory, seasonal (e.g. high season for product, clearance of inventory, holiday).

Additional data that may be considered in some embodiments of a routing engine are delivery channels available to the fulfillment node (e.g. slow or fast shipping carriers), designated hours of operation (e.g. currently operating or closed down), productivity or capacity (e.g. some may be faster or more productive than others or have more spare capacity). Also, data regarding transient conditions affecting productivity and the capabilities of fulfillment locations may be considered, e.g. unexpected shut downs or slow downs due to weather, labor action, or other issues, as well as natural disasters or accidents that may slow carriers. Some embodiments of a rules-based routing system in accordance with the present invention will be able to handle and weight routing options based on these types of data.

Also shown in FIG. 3 are data stores for the fulfillment networks for Client A 320, Client B 322, the enterprise 324, Vendor A 330, and Vendor B 332 for storing status from each of the fulfillment networks. For example, product inventory data for each site in the network may be stored. This data may be obtained, for example, by periodically polling the fulfillment network nodes for inventory data. Alternatively, this data may be obtained in response to a request for a specific product by querying the nodes of each fulfillment network for the data relating to the product requested. The fulfillment network data stored may also include data regarding specific fulfillment capabilities of each node of the network (e.g. overnight shipping, gift-wrapping, premium packaging), capacity of individual nodes, historical performance of nodes, and the age or condition of stock at various nodes. Note that the data discussed above may be pushed to the routing system based on events, e.g. change in inventory, such that it may be cached or stored in a readily accessible data store instead of being retrieved responsive to a query.

Further, customer data stores are shown in FIG. 3 for Client A 340, Client B 342 and the enterprise 344. Information pertaining to customers of each entity are stored and utilized for scoring or filtering available fulfillment options. For example, a high loyalty or premium service customer may be offered services, e.g. free overnight shipping, that may not be offered to other customers. In addition, a particular customer's service level for orders may be boosted by customer service in response to a customer complaint. Or a customer with a history of returning products for quality reasons may not be offered product where the quality is unknown and may be compromised, e.g. on-rack or salvage stock. Examples of customer data that may be utilized in accordance with some aspects of the present invention include: past purchases, return history, services utilized, browser history, spending (e.g. high value, mid-range, low), site navigation of other seller's sites, site navigation of enterprise's site, path through the enterprise's site, mobile device history, location of transactions (e.g. on-line, in-store), time of year (e.g. holiday seasonal), special products (e.g. size), location (e.g. mobile device in store v. not in store), loyalty (e.g. recency, frequency, long-term), risk of losing customer, response to sales, and others.

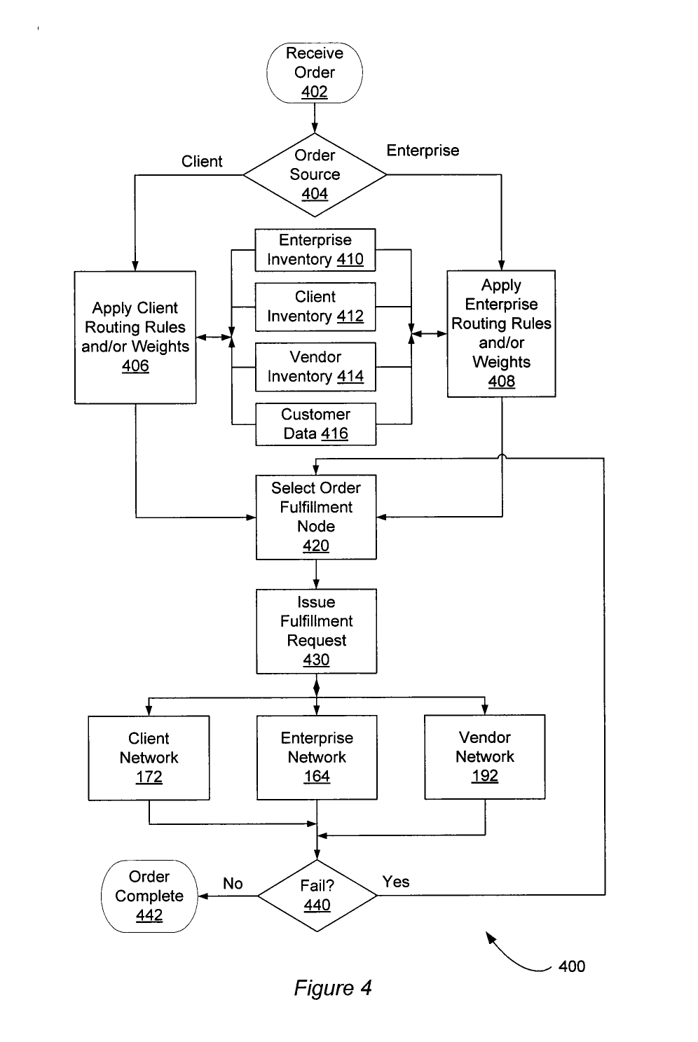

FIG. 4 is a control flow diagram illustrating an example in accordance with at least one embodiment of the invention of a process 400 for routing an order in a routing engine serving both an enterprise and a client and issuing fulfillment requests to heterogeneous fulfillment networks for the client 172, the enterprise 164 and a vendor 192. In this example, an order is received for a product and is handled differently depending on the origin of the order. In this example, if the order originates with the client order system 170, then the routing rules are applied with the client's specific factor weightings to score the fulfillment options at step 406. Alternatively, a set of routing rules specific to the client may be utilized to score the fulfillment options. Similarly, if the order originates with the enterprise ordering system 160, then the routing rules are applied with enterprise rules and/or weighting to score the available fulfillment options at step 408. In either approach, the inventory data of the enterprise network 410 and the client network 412 as well as customer data 416 are considered in scoring the available options. In addition, vendor inventory data 414 may be considered in routing rules.

In the example of FIG. 4, the process 400 proceeds to select an order fulfillment node at step 420 and issue a fulfillment request to the selected node at step 430, where the selected node proceeds to pick and ship the product for the customer. If the node fails to execute the fulfillment request, then control branches at step 440 back to step 420 so that a different node can be selected to fulfill the order.

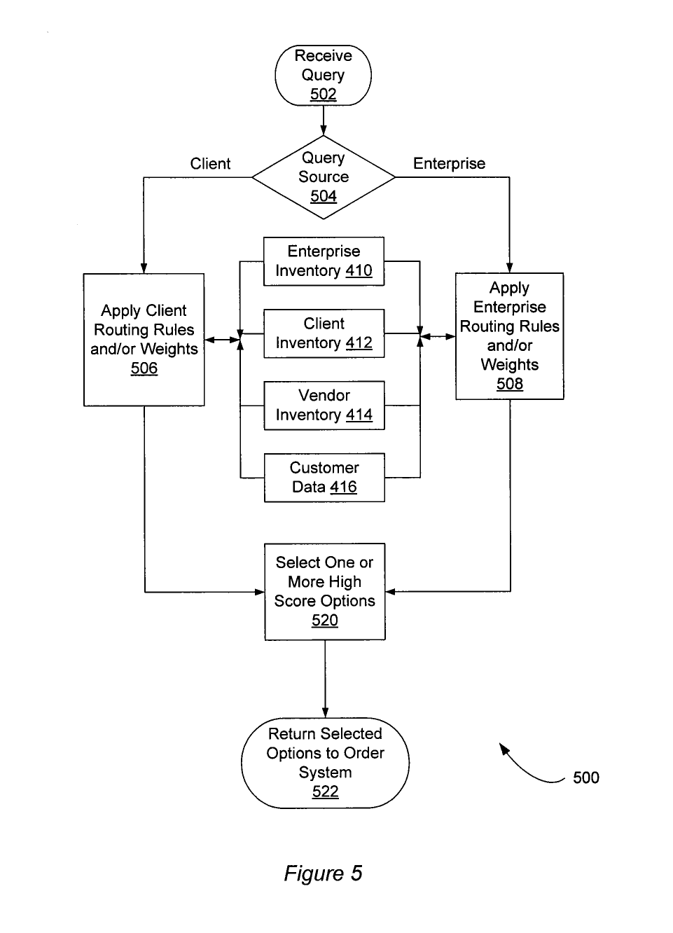

FIG. 5 is a control flow diagram illustrating an example in accordance with at least one embodiment of the invention of a process 500 for obtaining routing options available for a product in a routing engine serving both an enterprise and a client and based on real-time data from heterogeneous fulfillment networks for the client 412, the enterprise 410 and a vendor 414. In this example, an availability query is received for a product and is handled differently depending on the origin of the query. For example, if the query originates with the client order system 170, then control branches at step 504 to step 506 where the routing rules are applied with the client's specific weightings to score the fulfillment options. Alternatively, a set of client routing rules are utilized to score the fulfillment options. Similarly, if the order originates with the enterprise ordering system 160, then control branches to step 508 where the routing rules are applied with enterprise rules and/or weighting to score the available fulfillment options. In either approach, the inventory of the enterprise network 410, the client network 412 and the vendor network 414 as well as customer data 416 are considered in scoring the available options. As a result of having different weighting schemes, the same fulfillment option may receive a different score for the client than for the enterprise, e.g. a fulfillment option from the client fulfillment network 172 may be scored higher than one from the enterprise network for a query originating with client ordering system 170.

In the example of FIG. 5, the process 500 proceeds to select the highest scored fulfillment options and return the selected options to either the client 170 or enterprise 160 order system depending upon where the query originated. Note that other embodiments may factor in different or additional types of data, e.g. product data, such as size, weight, cost, margin, shipping restrictions, or class, which can affect routing decisions.

FIGS. 6, 7 and 8 are representational diagrams illustrating examples of user facing electronic commerce interfaces that may be presented to a user. For example, a customer may use such an interface via a website, e.g. a shopping cart window, or smart phone application or a salesperson may use such an interface on a point of sale or mobile device. The interface may also be supported by the customer ordering system of FIG. 1, which passes queries to the enterprise ordering system 160 and receives responses from the routing engine through the enterprise ordering system 160. Alternatively, the customer ordering system may communicate directly to the routing engine via an interface provided by the routing engine, such as an API, service call, or file transfer, e.g. XML document or spreadsheet. One of skill in the art will readily recognize that a suitable user interface may be implemented in a wide variety of ways and architectures.

FIG. 6 illustrates an interface that may be supported by the enterprise ordering system 160 of FIG. 1. The example shown is for Customer A who has selected or placed three products, Products A, B and C in the shopping cart. For each product, the enterprise ordering system 160 sent a query to the routing engine 162, which scored the available options for fulfilling a potential order for Customer A and returned three available options to the enterprise ordering system 160. For Product A, the routing engine 162 returned three fulfillment options for Customer A. One option is available from in store stock, such as retail store 254 local to Customer A, for $14.99, as determined by the routing engine from real-time inventory data from the enterprise fulfillment network as well as customer data, e.g. address. Product A is also available for $17.99 ground shipped from, for example, fulfillment center 242 in the enterprise's fulfillment network 164. Alternatively, if inventory status or routing rules or weights were different, Product A might be ground shipped from a warehouse in client fulfillment network 172 or vendor fulfillment network 192. The ultimate identity of the fulfillment network utilized to service the customer may be obscured from the customer or may be displayed, if desired. In addition, Product A is available for $21.99 overnight shipped from a reserve stock, such as RS 243 of FIG. 2, in the enterprise's fulfillment network 164 or another network, where the higher price may reflect the shipping cost. Lower scoring options, such as backorder 274 in vendor network 192, may not be offered or displayed.

Similarly, the routing engine 162 returned three options for Product B including discounted stock available at enterprise outlet store 244, in store stock at a local retail store 252 located near to Customer A, and ground shipping from vendor warehouse 270 in vendor network 192. For Product C, the routing engine provided three options including returned merchandise from a salvage center 246 in the enterprise network 164, store inventory at outlet store 244, or ground shipped from FC 242 in enterprise network 164. Another option, which was not shown on the user interface 600 due to its low score, was to have Product C manufactured on demand 276 in vendor network 192.

In the example of FIG. 6, the different options made available to this customer may be based on the customer's past history with the enterprise (e.g. an occasional purchaser of discounted items), the availability of the product at various nodes, the cost of the product, the cost of delivering the product to the customer, and the quality of the product. If Product A is a low margin product, for example, the options presented may reflect shipping costs for the product (i.e. no free shipping), or, if the customer has historically shown interest in deeply discounted product despite the possibility of reduced quality, the customer may be offered returned merchandise.

FIG. 7 illustrates another example of a user interface 700 that is also supported by the enterprise ordering system 160 of FIG. 1. In this example, a salesperson using a mobile client device has selected or placed three products in an electronic cart for high value Customer B, though a similar interface may be made available to Customer B through the customer's client device, e.g. smartphone 114 in FIG. 1. For each product, the enterprise ordering system 160 sent a query to the routing engine 162, which scored the available options for fulfilling a potential order for Customer B and returned three available options to the enterprise ordering system 160. For this example, Product X is an expensive item, such as a piece of high end clothing, and, due to the nature of the product as indicated, for example, in product specific data maintained by the fulfillment system, utilizing customer location data and fulfillment node capability data, the routing engine 162 returned only one fulfillment option at retail store 252 in FIG. 2, where tailoring service is available because the enterprise selected a routing schema designed to deliver a high value experience to the customer for this product or for high value products. Note that the routing schema in some embodiments may be configured to include rules that are specific to a particular product.

In another example, for Product Y, the routing engine 162 made overnight shipping at no cost an option for Customer B due to, for example, the historically high spending level of Customer B or the high value of Product Y or Customer B's overall order. For Product C, different options are made available to Customer B based on past customer history from the options made available to Customer A for Product C. Customer B is only offered overnight shipping from new quality stock from the vendor network at no shipping cost because of Customer B's high value or history of returning merchandise for quality issues. The example of FIG. 7 illustrates that, in one aspect of the present invention, routing rules or weights may be configured by the enterprise or clients to offer one customer different options for the same product than another customer.

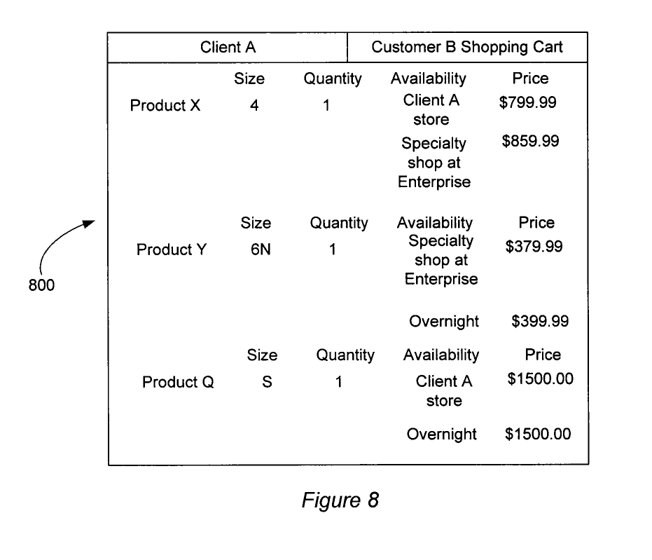

FIG. 8 illustrates another example of an interface 800 that is supported by the customer ordering system 170 of FIG. 1 rather than the enterprise ordering system 160. In this example, Customer B is being serviced from Client A's ordering system, where Client A sells high end products, and options are offered based on Client A's routing rules or weights as processed by the enterprise routing engine 162. In one embodiment, Client A's routing rules or weights are configured to favor fulfillment from Client A's fulfillment network 172, but still provide options from the enterprise fulfillment network 164.

Product X, which was only offered at an enterprise retail store in the customer interface example 700 of FIG. 7, is offered at a Client A retail store 224 at $799.99, but also offered from Client A's specialty shop 222 physically located in an enterprise retail store, e.g. a special retail facility inside the enterprise's store having Client A owned stock on the premises of the enterprise. In this example, the stock located at the specialty shop 222 is priced differently from the stock offered at Client A's retail store 224. Product Y is only offered at the specialty shop 222 located at an enterprise store, e.g. Client A does not independently stock Product Y at its own retail stores and relies on the enterprise's stock or Client A owned stock on enterprise premises to fulfill orders. Product Q is a specialty item offered exclusively through Client A's ordering interface, e.g. customers are not able to order it through the enterprise order system, and the fulfillment options offered are solely from store 228 in Client A's fulfillment network 172, e.g. Client A's retail store or overnight shipped at no additional cost from Client A's fulfillment center 212.

The example of FIG. 8 illustrates that, in accordance with one aspect of the present invention, routing rules or weights may be configured by the client to offer customers options through the client order system 170 that are different from those offered by the enterprise order system 160 for the same products even though the enterprise routing engine 162 is determining the available options. Thus, customers may be directed to the client's retail channels for a product rather than the enterprise's channels. In addition, products may be made available to customers through the client's ordering system 170 that are not available through the enterprise ordering system 160, but options and fulfillment are still managed by the enterprise routing engine 162.

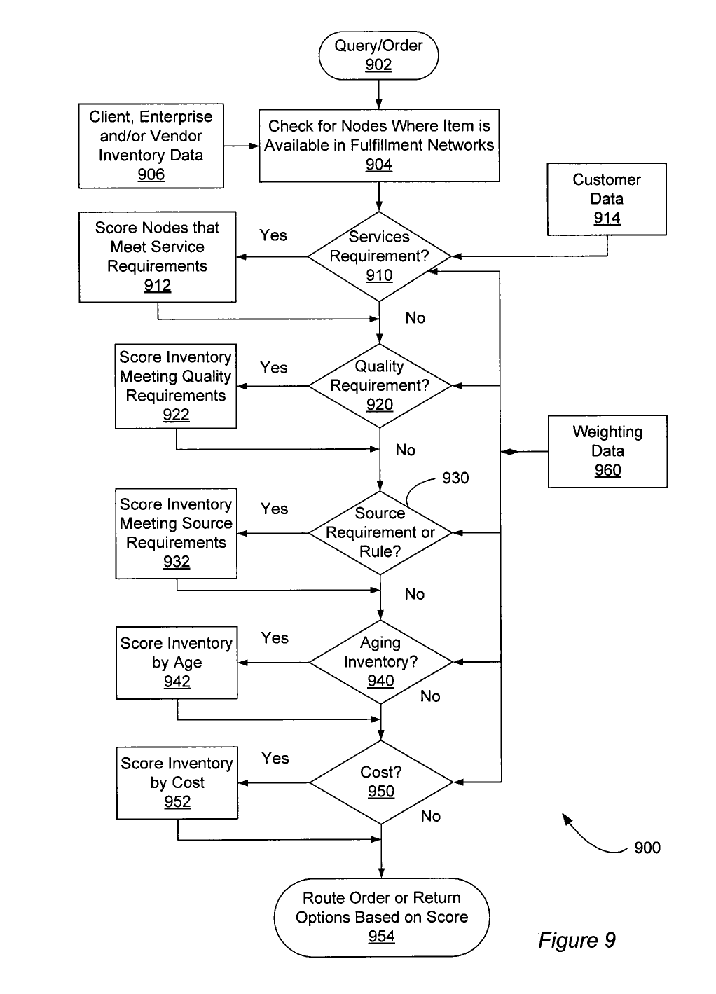

FIG. 9 is a control flow diagram illustrating an example of a process 900 for scoring an order or a query for routing in the routing engine of FIG. 1 using multiple factors in order to apply weighted routing rules in accordance with at least one embodiment of the invention. In this example, at step 902, the query or order is received in the routing engine 162 from the enterprise ordering system 160 of FIG. 1, though, in other examples, the order or query may originate with a client ordering system, such as client ordering system 170. At step 904, routing engine 162 checks to see which of the fulfillment network nodes stocks the product based on inventory data 906. The inventory data 906 may be retrieved by real-time access to one or more of the enterprise 164, vendor 192 and client 172 fulfillment networks, through periodic queries to the networks, or a combination of these approaches to establish the current availability of the product in inventory.

The process 900 in routing engine 162 utilizes the routing rules and/or weighting schema defined in the data store 180 coupled to the routing engine 162 to assess the available fulfillment options. Note that the scores are cumulative in this example. Other routing processes may alter this approach, such as using a threshold against a score or additional, fewer or different factors may be considered. In this example, if there is a service level requirement, then control branches at step 910 to step 912 where the first factor scored is whether particular services are required, e.g. tailoring, gift wrapping, or overnight shipping, or offered for the particular customer, e.g. overnight shipping for preferred customers. The special services may, for example, arise out of the nature of the product, e.g. Product X in FIG. 7, or the customer data 914. If special services are required, then the fulfillment nodes with those services are scored at step 912 on that basis, the score is scaled based on the associated weighting factor from weighting data 960, and nodes unable to provide the service are removed from further consideration. Alternatively, no nodes are removed from consideration and all nodes are evaluated based on score.

If there are particular quality requirements, then control branches at step 920 to step 922, where the routing engine 162 checks the fulfillment nodes for whether the available product at that node meets the quality requirement, scores the node accordingly, and scales the score for the quality factor based on weighting data 960. For example, returned stock or outlet stock for Product C is offered to Customer A in FIG. 6, but not to Customer B in FIG. 7.

If there is a sourcing requirement or rule, control branches at step 930 to step 932 for consideration of inventory that meets the sourcing requirement. For example, if the order or query arises from the enterprise ordering system 160, then the enterprise's sourcing rules and/or weights are utilized, which are configured to favor nodes within the enterprise fulfillment network 164. Similarly, if the order or query arises from the client ordering system 170, then the rules and weights defined by the client are applied, which is configured to favor nodes within the client fulfillment network 172. This is illustrated in the different results for Customer B in FIGS. 7 and 8.

Another factor that is considered in this example is the age of inventory. Control branches at step 940 to step 942 where the inventory available at the nodes under consideration is scored based on its age, e.g. older inventory is scored higher than new inventory, in order to favor the use of aging inventory to fulfill the order.

If cost is a factor in the fulfillment schema, then control branches at step 950 to step 952, where the inventory available at the nodes under consideration is scored based on the cost to fulfill using that inventory. For example, inventory at a low cost fulfillment node, e.g. one with lower delivery costs, is scored higher than inventory at fulfillment nodes with higher fulfillment costs in order to favor fulfillment from the lowest cost nodes. Alternatively, lower cost inventory may be favored for delivery over higher cost inventory.

At step 954, the best scored option available is returned to step 420 of fulfillment process 400 in FIG. 4 for fulfillment of an order or one or more of the best scored options are returned to step 520 in the query options process 500 of FIG. 5 so that they may be displayed to a customer or other entity who sent the query.

The example of customer results shown in FIG. 7 arise as a result of the process of FIG. 5 proceeding along the enterprise branch to step 508, which may be implemented in the manner of process 900 of FIG. 9 with the enterprise rules and weights. Note that as a result of applying the enterprise rules and weights to the scoring of options, Product X is indicated in FIG. 7 as being only available in an enterprise retail store, such as retails stores 252, 254 and 256 illustrated in FIG. 2, where value added services for the product, e.g. tailoring, are available.

In the example of customer results shown in FIG. 8, the order or query originated with the client ordering system 170 resulting in the processing of FIG. 5 proceeding along the Client branch to step 506, wherein the Client's rules or weights are applied to the scoring of options. As a result, only client fulfillment network 172 options are shown in the example of FIG. 8 even though options exist involving non-Client fulfillment network nodes. Also, note that different pricing may be offered through the Client schema compared to the enterprise. For example, Product X is offered to the customer in FIG. 8 at the Client's specialty shop located in the Enterprise's retail stores, but at a higher price than at the Client's own retail stores. This may represent, for example, Client's premium branding that permits different pricing. Further, some products may only be made available through the Client's fulfillment network, as illustrated with regard to Product Q.

Variations on the process 900 of FIG. 9 may be made with respect to other aspects of the present invention. For example, different, more or less factors than those shown in FIG. 9 may be utilized without departing from the invention. In other embodiments, options presented may change based on the categories browsed by a user or other user behavior data. In still another embodiment, options may be evaluated iteratively. For example, as items are added to a queue or shopping cart, the options with regard to the type of products or value added services may be changed, fulfillment nodes closest to the customer's location may be scored higher, or stock for items in the cart may be reserved for the customer. In another example, the cost score may change when multiple items can be fulfilled from the same fulfillment node and the resulting cost to deliver, e.g. shipping costs, are lower in aggregate. Also, a high value customer or a customer with a historically high commit rate, e.g. usually buys an item once it's placed in the cart, may have stock reserved in inventory to fulfill their order if they commit the transaction.

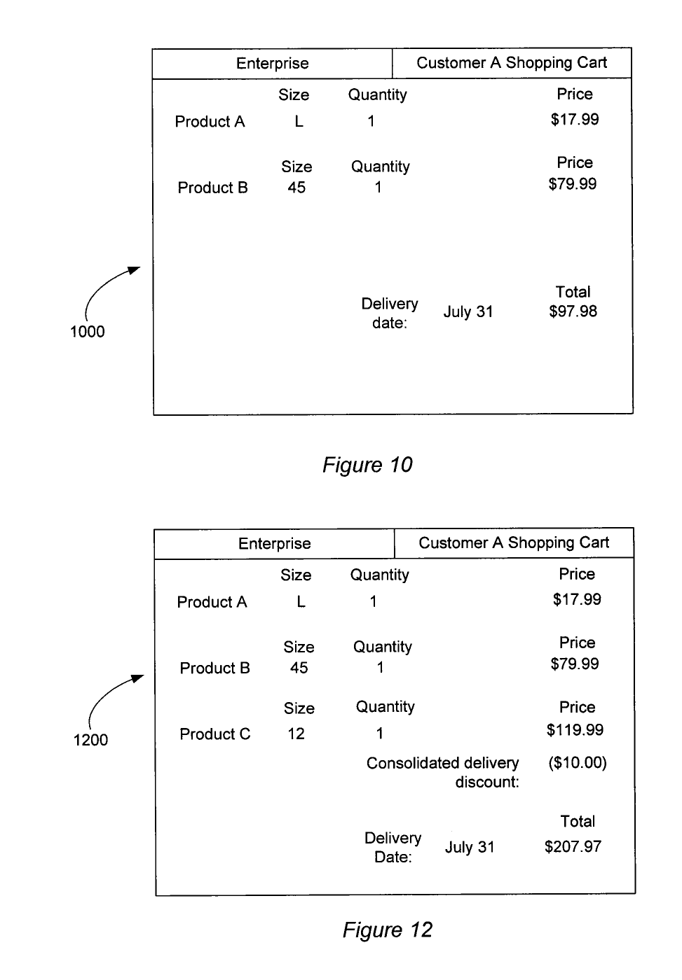

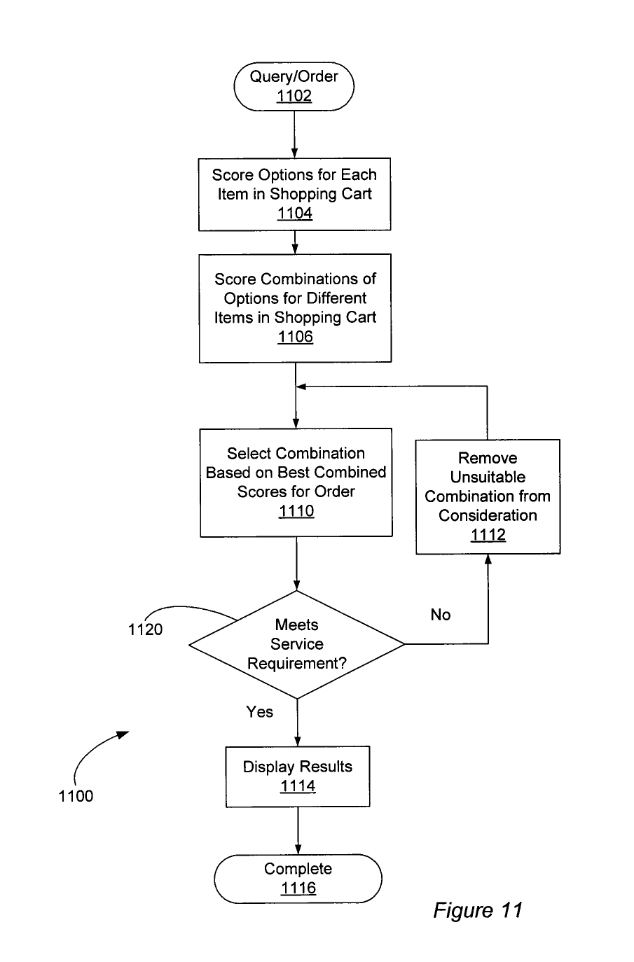

FIGS. 10 and 11 illustrate an example of an aspect of the present invention where fulfillment options are evaluated based on a level of operational cost for fulfillment and whether the resulting option meets a service requirement for the order, e.g. based on overall customer service policy or service policy for a particular type of customer or order. FIG. 10 illustrates an interface that may be supported by the client 170 or enterprise 160 ordering systems of FIG. 1. FIG. 10 shows an example at a point where Customer A has selected two products, Products A and B, for the electronic shopping cart. In this example, the ordering system sent a query to the routing engine, which scored the available options for fulfilling the order for Customer A based on all the items in the order.

FIG. 11 is a control flow diagram that illustrates an example of a process 1100 for scoring fulfillment options based on a combination of items in a customer order in accordance with at least one aspect of the present invention. In this example, at step 1102, the routing engine 162 receives a fulfillment query or a customer order and, at step 1104, scores the fulfillment options for each item in the customer order, e.g. electronic shopping cart. At step 1106, the routing engine 162 proceeds to score combinations of fulfillment options for the different items in the customer order. For example, if Product A and Product B can be shipped from one fulfillment center in a single shipment, then the fulfillment option is scored based upon shipping the two items together from that fulfillment center. One of skill in the art will recognize that the process illustrated in FIG. 9 may be utilized or adapted for use in scoring fulfillment combinations. Another fulfillment center may also be able to ship both products, so that option is also scored based upon consolidated shipping. Partial combinations, e.g. two products from one fulfillment center and a third product from a different fulfillment center, may also be considered and scored.

Once a set of combined fulfillment options has been scored, the process 1100 selects a fulfillment combination based on the best combined score for the order at step 1110. For example, the routing rules and weights in FIGS. 4 and 9 may be selected to pursue a strategy of lowest operational cost for fulfillment, where operational cost is evaluated based on selected criteria, such as shipping cost, handling cost, consolidation, speed of delivery, or node capacity. In an alternative embodiment, the set of scored fulfillment combinations may be rank ordered based on the score with the lowest cost option selected. Alternatively, a fulfillment option that meets a selected threshold might be chosen instead of the lowest cost option. In still another alternative embodiment, the fastest delivery amongst the options at a given cost level may be selected. One of skill in the art will appreciate that a variety of permutations of a selection process may be achieved through the selection of routing rules and weights without departing from the teaching of the invention.

In the example embodiment shown in FIG. 11, the process 1100 checks whether the selected fulfillment option meets a service requirement at step 1120. For example, an enterprise might require that the customer receive the order within three days. By way of another example, the enterprise may require that the particular customer receives their orders overnight. If the selected option meets the service requirement, then process 1100 branches to step 1114 where it returns the selected combination to the customer order service or system 160 or 170 for display to the customer. If the selected option does not meet the service requirement, then control branches to step 1112 where that option is discarded and another fulfillment option, e.g. the next best available option in the rank order, is selected. This process continues until an option is selected that meets the service requirement. Thus, the fulfillment option with the best lowest operational cost that meets the service requirement is selected for fulfillment of the order. Note that checking the service requirement separately is an optional feature. In some alternative embodiments, service level would be considered in the scoring options and not independently or not considered at all.

As items are added to the order, the fulfillment combinations may be re-evaluated in some embodiments. FIG. 12 illustrates an example of a customer order interface 1200 that may be supported by the client 170 or enterprise 160 ordering systems of FIG. 1. In the example of FIG. 12, Product C has been added to the shopping cart by Customer A and the fulfillment options have been re-evaluated. In the example shown, all three products can be fulfilled in a consolidated delivery from a single fulfillment node and a $10.00 consolidation discount is reflected on the order interface. Alternatively, no discount is offered to the customer, but the fulfillment option selected for the order is the lowest operational cost option for the enterprise or client.

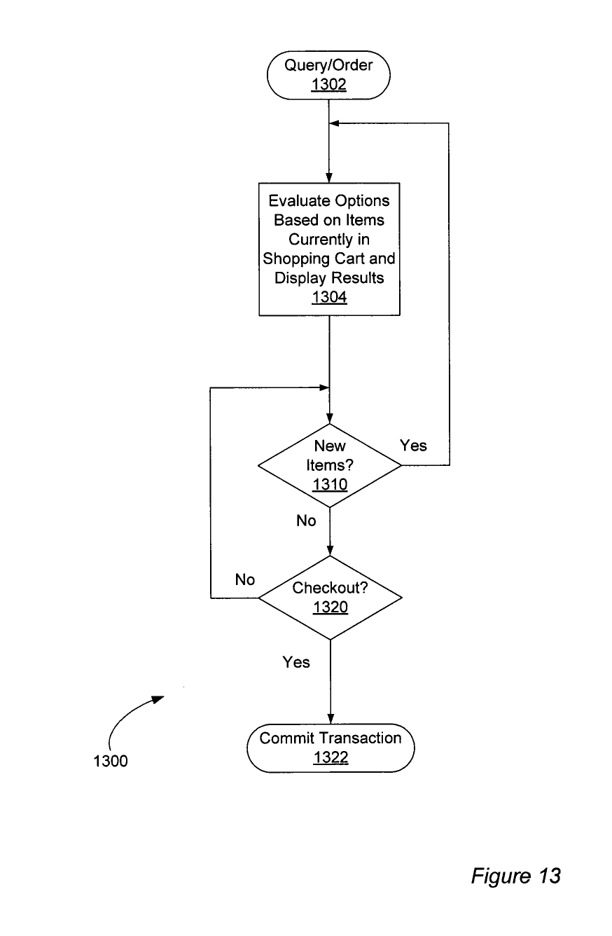

In the example of FIG. 12, the addition of Product C triggered a re-evaluation of the fulfillment options. FIG. 13 is a control flow diagram illustrating an example of an automated process 1300 for evaluating fulfillment options as additional products are added to the customer's order. When a customer service interface, e.g. customer order system or point of service device, first inquired about products or added products to the order, the query or order was sent to the routing engine 162, step 1302, to evaluate fulfillment options at step 1304 based on the items currently selected, an example of which is illustrated in FIG. 11. At step 1310, the process 1300 of FIG. 13 checks to see if new items have been added to the shopping cart, which may be done periodically or responsive to an event such as the addition of a new item to the cart. If a new product has been added, then control flows back to step 1304 and the fulfillment options are re-evaluated based on the new collection of items selected, e.g. in accordance with the process of FIG. 11. If no new items are added, the process 1300 checks whether the customer has requested checkout at step 1320. If the customer does request checkout, in this example, the system proceeds to step 1322 to commit the transaction and execute fulfillment. If the customer does not request checkout, then the system returns to checking for new items at step 1310. The example of FIG. 13 illustrates one approach to a process for re-evaluating the fulfillment options as products are added to an order or query. It will be appreciated by those of skill in the art that other approaches are possible without departing from this aspect of the present invention.

Also note that in the customer interface example 1200 of FIG. 12, only a service commitment, e.g. a delivery date of July 31, for the entire order is displayed to the customer. Aside from offering a consolidated delivery discount, which is optional, no information regarding the cost of fulfillment, such as the shipping costs, is shown. The price and delivery option shown may be based on the best operational cost for the enterprise to fulfill the order rather than the multiple prices and delivery options shown in the example of FIG. 6. Thus, the fulfillment system is free to select any fulfillment option that achieves the delivery date and the manner in which the order is fulfilled or delivered is not shown to the customer. The option shown to the customer could be fulfilled by shipping each item from separate fulfillment centers or by consolidating the order and shipping it from one fulfillment center.

Comparing the displayed data of example 1200 of FIG. 12 to the example 600 of FIG. 6, which also involves an order containing Products A, B and C, the fulfillment system 150 may ship all the items by ground in the example of FIG. 12 even though one or both of the items are available at a store local to Customer A because the overall operation cost to the enterprise in fulfilling the order is less than shipping the two items from the store or shipping overnight. Alternatively, all three items may be overnighted from a fulfillment center because the net cost for servicing the order will be less than servicing the order through ground from multiple fulfillment centers. Nonetheless, in the example of FIG. 12, the total price of the order shown to the customer is based on the enterprise's cost to deliver the order and any variability in operational cost, e.g. delivery cost, is obscured from the customer.

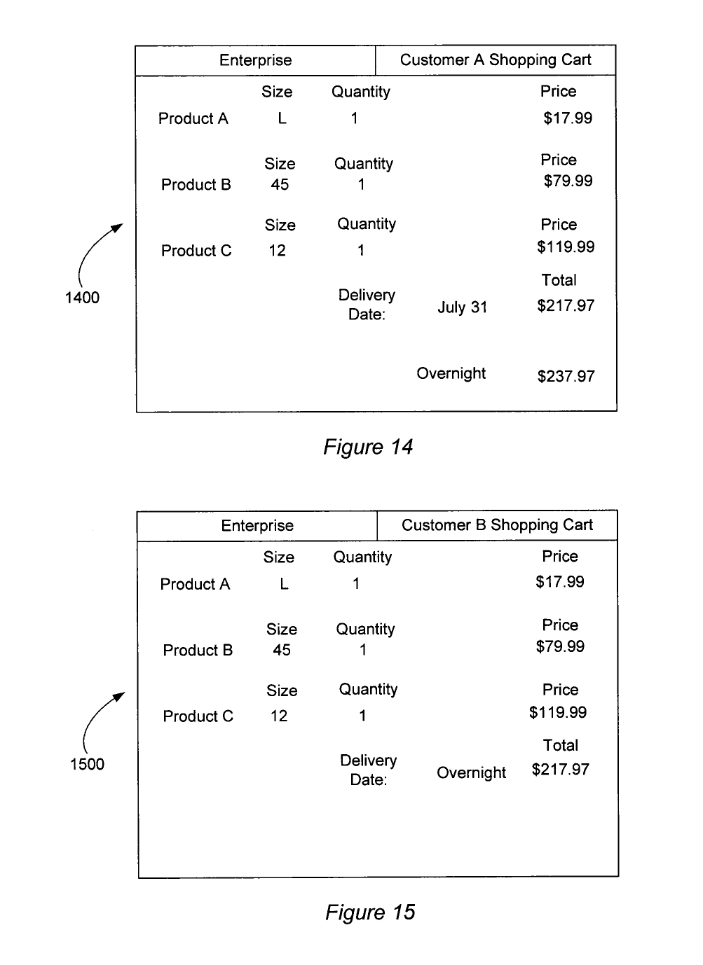

As noted above with respect to FIG. 12, the consolidated delivery discount is optional. In the customer interface example 1400 of FIG. 14, the customer is offered a July 31 fulfillment at a price of $217.97, which doesn't reflect the $10 consolidation discount. The routing engine can fulfill the order in any manner that meets the enterprise's policy goals, as reflected in the routing rules and weights.

The example of FIG. 14 illustrates an overnight shipping option at an additional cost of $20. The enterprise may wish to fulfill overnight at no additional cost to the customer, as shown in the example 1500 of FIG. 15. The routing rules or weights for the enterprise may be configured to provide upgraded service, e.g. for a particular customer.

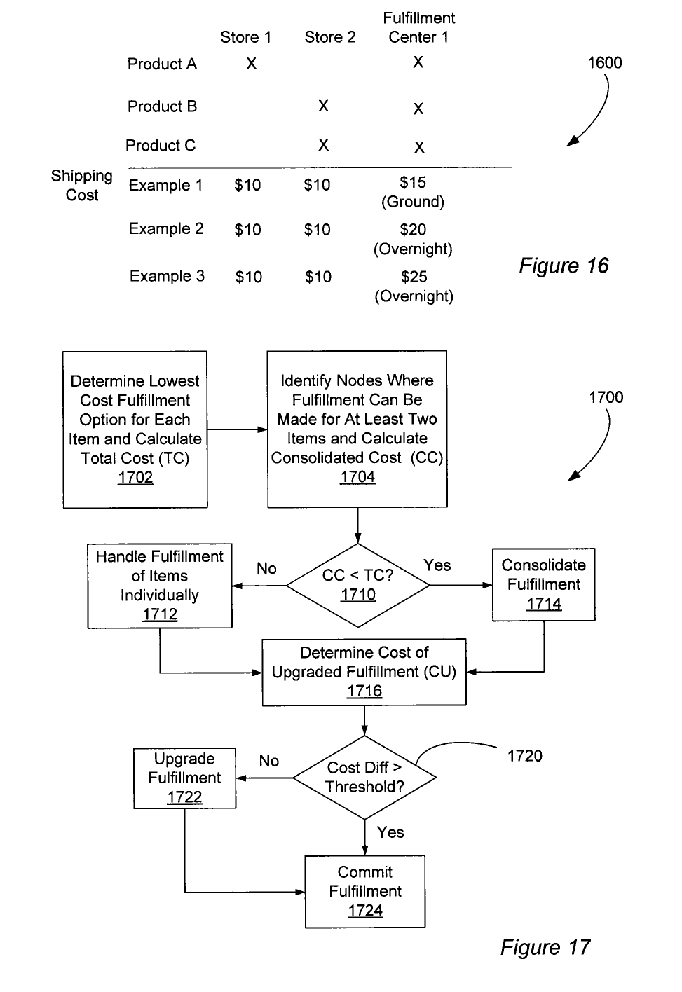

However, upgraded service may be provided because the enterprise can fulfill the order at lower operational cost on a consolidated basis than can otherwise be provided. FIG. 16 illustrates examples of several fulfillment options where the routing engine 162 may select consolidated fulfillment or upgraded delivery service. In the example of FIG. 16, Product A can be fulfilled from Store 1 at a cost of $10, but Store 1 cannot fulfill for Products B and C. Store 2 can fulfill for Products B and C at a cost of $10, but cannot fulfill Product A. Fulfillment Center 1 can fulfill Products A, B and C with ground shipping at a cost of $15 or overnight at a cost of $20.

In some embodiments, the routing engine 162 may be configured to check and compare the total cost of fulfillment. FIG. 17 is a control flow diagram illustrating one example of a process 1700 for analyzing the cost for fulfillment options on a consolidated basis, compare the consolidated cost to the cost of non-consolidated fulfillment, determine whether to employ a consolidated fulfillment option, and assess upgrading of service. In this example, at step 1702, the lowest cost fulfillment option for each item is calculated to obtain the Total Cost for the order if not consolidated. At step 1704, fulfillment nodes are identified where multiple items in the order can be fulfilled and the Consolidated Cost is calculated for consolidating fulfillment from these nodes. At step 1710, the consolidated cost is compared to the total cost. If the consolidated cost is less than the total cost for fulfillment, then control branches to step 1714 and the order fulfillment is consolidated. If the consolidated cost is not less than the total cost, then control branches to step 1712 and fulfillment proceeds by handling the items individually. At step 1716, the cost for upgraded fulfillment, e.g. overnight service, is determined. If the difference in cost for the service upgrade is less than a pre-determined or selected threshold value, then control branches at step 1720 to step 1722 where the service is upgraded and on to step 1724 to commit the fulfillment. If the cost difference is greater than the threshold, then control branches at step 1720 to step 1724 to commit the fulfillment without the service upgrade.

In the example of FIG. 16, one fulfillment option is to fulfill Product A from Store 1 and fulfill Products B and C from Store 2 at a total fulfillment cost of $20, e.g. $10 for Store 1 and $10 for Store 2. This is the total cost for fulfilling the order from Stores 1 and 2, e.g. shipping and handling for ground shipments of Product A from Store 1 and Products B and C from Store 2, which is determined at step 1702. Fulfillment Center 1 can make a consolidated shipment of Product A, B and C at a cost of $15 for ground service, which is determined at step 1704. Because the consolidated cost is less than the total cost, at step 1710, the consolidated shipment is chosen for fulfillment.

Next, in the example of FIGS. 16 and 17, the process 1700, at step 1716, determines the cost for upgrading service, e.g. shipping overnight, whether the shipment is consolidated or not. In Example 2 in FIG. 16, the cost for overnight shipping from Fulfillment Center 1 for all three products is $20. In Example 3, the overnight cost is $25. If the upgrade cost threshold is $5, then, in Example 2, the shipment is upgraded to overnight service at step 1722. In Example 3, the cost exceeds the threshold, and the consolidated shipment is not upgraded, but is sent by the standard ground service at step 1724. One of skill in the art will appreciate that many variations can be introduced to the process shown without diverging from this aspect of the present invention pertaining to consolidating fulfillment or upgrading service. By way of another example, the process may be configured such that fulfillment from a remote fulfillment center, e.g. Fulfillment Center 1, will be chosen only if the quality of service for the consolidated shipment matches the quality of service of the individual shipments, e.g. overnight or two day.

In another aspect of the present invention, the enterprise fulfillment system provides an interface for business intelligence to Clients. For example, based on sales in one or more fulfillment networks, the enterprise fulfillment system may evaluate the impact of different business models on sales volume, margin, cost or other factors. Alternatively, the system may make suggestions for different business models or different rules or weights that may improve sales, volume, margin, cost or other factors. FIG. 20 is a functional block and logical diagram illustrating one detailed embodiment according to at least one aspect of the present invention.

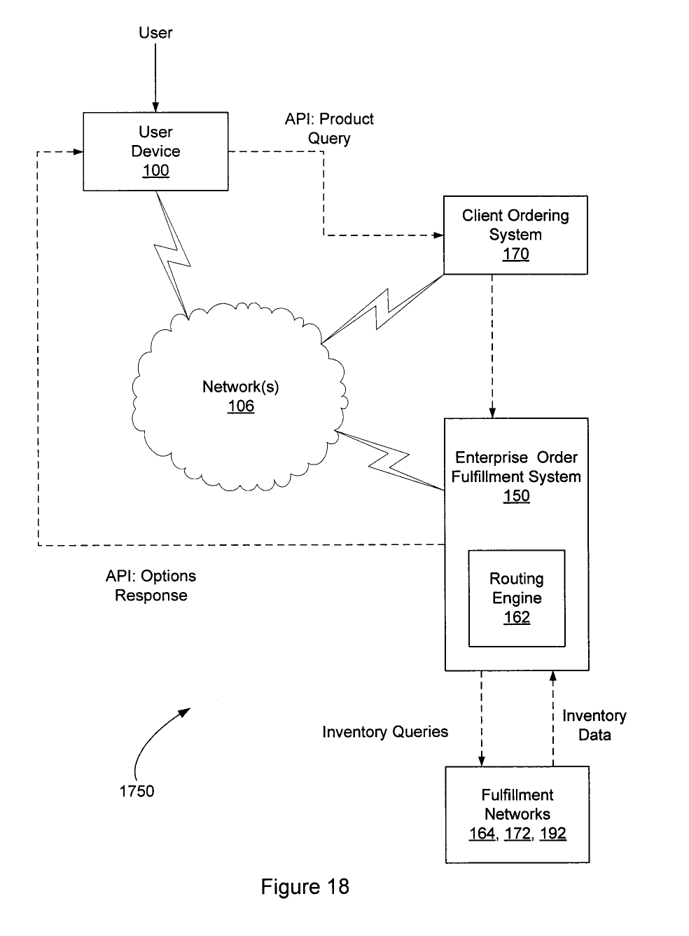

As noted above, in some embodiments, a customer device may provide a network based commerce interface for inputting product queries and displaying fulfillment options. FIG. 18 is a functional block diagram illustrating an example 1750 of the logical function of the system illustrated in FIG. 1 in accordance with one aspect of the present invention wherein an Application Program Interface (API) provides a web interface to a user for accessing a routing service. As discussed above, a user (e.g. an end customer or a salesperson) utilizes a client device 100 having an application or browser based interface to, in this example, send product inquiries to a client ordering system 170. In this embodiment, the client ordering system 170 receives a product query from the user's client device 100 and redirects the query to the enterprise ordering fulfillment system 150, which processes the user's query based on the client's routing schema. The enterprise order fulfillment system 150 then provides a response, which is generated as discussed above, for example, to the user's query directly to the user's client device 100 via the network API interface. In this manner, the enterprise order fulfillment system 150 can provide the backend fulfillment service for the client ordering system 170 so that the client may be relieved of providing an infrastructure for a fulfillment service in a manner that can obscure the fact that the enterprise provides the service, if that is desired by the client.

In accordance with at least one embodiment of the invention, the system, apparatus, methods, processes and/or operations for extension management may be wholly or partially implemented in the form of a set of instructions executed by one or more programmed computer processors, such as a central processing unit (CPU) or microprocessor. Such processors may be incorporated in an apparatus, server, client or other computing device operated by, or in communication with, other components of the system.

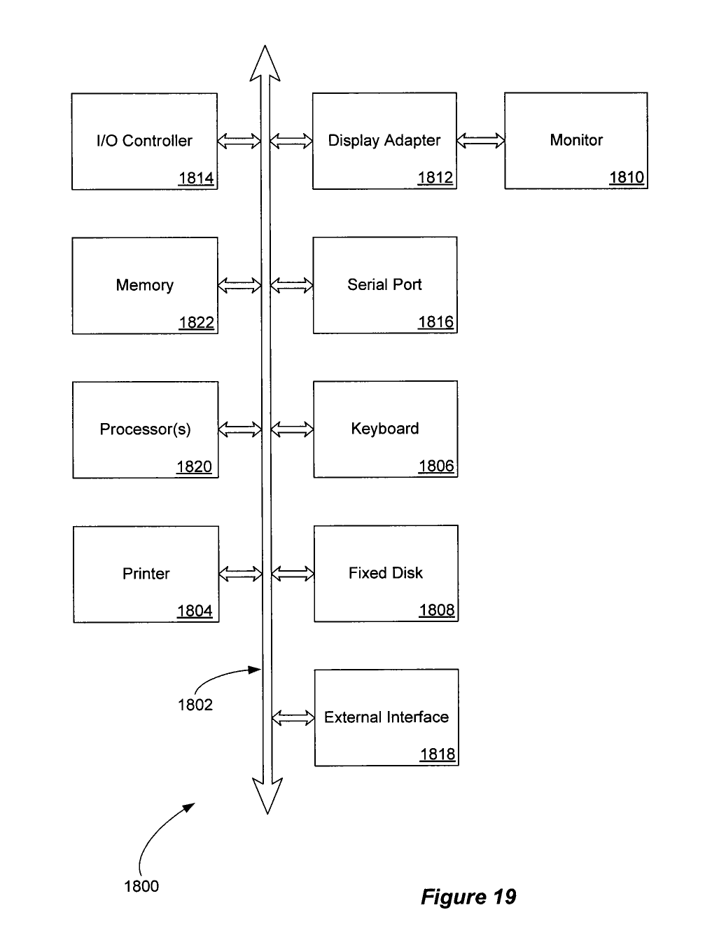

As an example, FIG. 19 depicts aspects of elements that may be present in a computer device and/or system 1800 configured to implement a method and/or process in accordance with some embodiments of the present invention. The subsystems shown in FIG. 19 are interconnected via a system bus 1802. Additional subsystems include a printer 1804, a keyboard 1806, a fixed disk 1808, and a monitor 1810, which is coupled to a display adapter 1812. Peripherals and input/output (I/O) devices, which couple to an I/O controller 1814, can be connected to the computer system by any number of means known in the art, such as a serial port 1816. For example, the serial port 1816 or an external interface 1818 can be utilized to connect the computer device 1800 to further devices and/or systems not shown in FIG. 19 including a wide area network such as the Internet, a mouse input device, and/or a scanner. The interconnection via the system bus 1802 allows one or more processors 1820 to communicate with each subsystem and to control the execution of instructions that may be stored in a system memory 1822 and/or the fixed disk 1808, as well as the exchange of information between subsystems. The system memory 1822 and/or the fixed disk 1808 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the invention.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. An enterprise fulfillment system for order fulfillment from a heterogeneous fulfillment network, the system comprising at least one server configured to:
communicatively connect to at least one communication network, the communication network providing communication to the heterogeneous fulfillment network and at least one ordering system;
obtain current inventory data from a plurality of nodes of the heterogeneous fulfillment network;
receive a customer query regarding a first product from the ordering system;
responsive to the customer query, identify one or more nodes in the fulfillment network having stock corresponding to the first product;
score a plurality of fulfillment options from the nodes in the fulfillment network having stock corresponding to the first product based on a first routing schema; and
send a reply to the ordering system, the reply including one or more of the scored fulfillment options based on a rank order.

2. The system of claim 1, where the first routing schema further comprises a first set of rules.

3. The system of claim 2, where the first routing schema further comprises a first set of weightings corresponding to the first set of rules.

4. The system of claim 3, where the system further includes an interface configured to permit revision of the first set of weights.

5. The system of claim 2, where the system further includes an interface configured to permit dynamic revision of the first set of weights.

6. The system of claim 1, where the server is further configured to obtain the current inventory data from the heterogeneous fulfillment network by periodically querying the nodes of the heterogeneous fulfillment network for inventory data.

7. The system of claim 1, where the server is further configured to obtain the current inventory data from the heterogeneous fulfillment network by querying the nodes of the heterogenous fulfillment network for inventory data for the first product responsive to receiving the query.

8. The system of claim 1, where the server is further configured to score fulfillment options from the plurality of fulfillment nodes in the fulfillment network having stock corresponding is further configured to evaluate nodes on the basis of multiple factors from the set of quality, capacity, value added services available, cost, shipping services available, cost of shipping, location proximate to an end customer for the product, age of inventory, quality of inventory, price, velocity of sales, margin, and customer history.

9. The system of claim 8, where the server is further configured to score fulfillment options by providing premium customers with options that are not presented to non-premium customers.

10. The system of claim 8, where the server is further configured to score fulfillment options by providing at least one option for a high value product that is not offered for lower valued products.

11. The system of claim 10, where the at least one option includes at least one of free shipping and modification of the product.

12. The system of claim 1, where the heterogeneous fulfillment network further comprises multiple heterogeneous fulfillment networks.

13. The system of claim 12, where the multiple heterogeneous fulfillment networks include multiple ones of a client fulfillment network, an enterprise fulfillment network and a vendor fulfillment network.

14. The system of claim 12, where the server is further configured to obtain current inventory data from at least one node of the heterogeneous fulfillment network by obtaining current inventory data from at least one node of the multiple heterogeneous fulfillment networks.

15. The system of claim 14, where the server is further configured to identify nodes in the fulfillment network having stock corresponding to the first product by identifying nodes in the multiple fulfillment networks having stock corresponding to the first product.

16. The system of claim 15, where the server is further configured to score fulfillment options by applying the first routing schema to the first product for a customer query received from an enterprise ordering system and a second routing schema for a customer query received from a client ordering system.

17. A method for automatically determining fulfillment options in a heterogenous fulfillment network, the method comprising:
obtaining current inventory data from at least one node of the heterogeneous fulfillment network;
receiving a query regarding a first product;
responsive to the query, identifying nodes in the fulfillment network having stock corresponding to the first product;
scoring fulfillment options from each of the nodes having stock corresponding to the first product based on a first routing schema; and
returning at least one fulfillment option based on a rank order of the scored fulfillment options.

18. The method of claim 17, where the first routing schema further comprises a first set of rules.

19. The method of claim 18, where the first routing schema further comprises a first set of weightings corresponding to the first set of rules.

20. The method of claim 19, the method further comprising the step of revising the first set of weights.

21. The method of claim 18, the method further comprising the step of dynamically revising the first set of weights.

22. The method of claim 17, where the step of obtaining current inventory data from at least one node of the heterogeneous fulfillment network further comprises periodically querying the nodes of the network for inventory data.

23. The method of claim 17, where the step of obtaining current inventory data from at least one node of the heterogeneous fulfillment network further comprises querying the nodes of the network for inventory data for the first product responsive to receiving the query.

24. The method of claim 17, where the step of scoring fulfillment options from each of the nodes having stock corresponding to the first product based on a first routing schema further includes evaluating nodes on the basis of multiple factors from the set of quality, capacity, value added services available, cost, shipping services available, cost of shipping, location proximate to an end customer for the product, age of inventory, quality of inventory, price, velocity of sales, margin, and customer history.

25. The method of claim 24, where the step of scoring fulfillment options further includes providing premium customers with options that are not presented to non-premium customers.

26. The method of claim 24, where the step of scoring fulfillment options further includes providing at least one option for a high value product that is not offered for lower valued products.

27. The method of claim 26, where the at least one option includes at least one of free shipping and modification of the product.

28. The method of claim 17, where the heterogeneous fulfillment network further comprises multiple heterogeneous fulfillment networks.

29. The method of claim 28, where the multiple heterogeneous fulfillment networks include multiple ones of a client fulfillment network, an enterprise fulfillment network and a vendor fulfillment network.

30. The method of claim 28, where the step of obtaining current inventory data from at least one node of the heterogeneous fulfillment network further comprises obtaining current inventory data from at least one node of the multiple heterogeneous fulfillment networks.

31. The method of claim 30, where the step of identifying nodes in the fulfillment network having stock corresponding to the first product further comprises identifying nodes in the multiple fulfillment networks having stock corresponding to the first product.

32. The method of claim 31, where the step of scoring fulfillment options from each of the nodes having stock corresponding to the first product based on a first routing schema further comprises applying the first routing schema to the first product for a query received from an enterprise ordering system and a second routing schema for a query received from a client ordering system.

33. A computer readable medium having computer-executable instructions stored thereon which, when executed by a computer, will cause the computer to perform a process for automatically determining fulfillment options in a heterogenous fulfillment network comprising the steps of:
obtaining current inventory data from at least one node of the heterogeneous fulfillment network;
receiving a query regarding a first product;
responsive to the query, identifying nodes in the fulfillment network having stock corresponding to the first product;
scoring fulfillment options from each of the nodes having stock corresponding to the first product based on a first routing schema; and
returning at least one fulfillment option based on a rank order of the scored fulfillment options.

34. The computer readable medium of claim 33, where the first routing schema further comprises at least one of a first set of rules and a first set of weightings.

35. The computer readable medium of claim 34, where the process includes providing an interface for revising at least one of the first set of rules and the first set of weights.

36. The computer readable medium of claim 34, where the process includes dynamically revising the first set of weights.

37. The computer readable medium of claim 33, where the obtaining current inventory data from at least one node of the heterogeneous fulfillment network further comprises one of periodically querying the nodes of the network for inventory data and querying the nodes of the network for inventory data for the first product responsive to receiving the query.

38. The computer readable medium of claim 33, where the scoring fulfillment options from each of the nodes having stock corresponding to the first product based on a first routing schema further includes evaluating nodes on the basis of multiple factors from the set of quality, capacity, value added services available, cost, shipping services available, cost of shipping, location proximate to an end customer for the product, age of inventory, quality of inventory, price, velocity of sales, margin, and customer history.

39. The computer readable medium of claim 38, where the scoring fulfillment options further includes providing premium customers with options that are not presented to non-premium customers.

40. The computer readable medium of claim 38, where the scoring fulfillment options further includes providing at least one option for a high value product that is not offered for lower valued products.

41. The computer readable medium of claim 40, where the at least one option includes at least one of free shipping and modification of the product.

42. The computer readable medium of claim 33, where the heterogeneous fulfillment network further comprises multiple heterogeneous fulfillment networks.

43. The computer readable medium of claim 42, where the multiple heterogeneous fulfillment networks include multiple ones of a client fulfillment network, an enterprise fulfillment network and a vendor fulfillment network.

44. The computer readable medium of claim 42, where the obtaining current inventory data from at least one node of the heterogeneous fulfillment network further comprises obtaining current inventory data from at least one node of the multiple heterogeneous fulfillment networks.

45. The computer readable medium of claim 44, where the identifying nodes in the fulfillment network having stock corresponding to the first product further comprises identifying nodes in the multiple fulfillment networks having stock corresponding to the first product.

46. The computer readable medium of claim 44, where the scoring fulfillment options from each of the nodes having stock corresponding to the first product based on a first routing schema further comprises applying the first routing schema to the first product for a query received from an enterprise ordering system and a second routing schema for a query received from a client ordering system.
